(19) United States
(12) Patent Application Publication
(10) Pub. No.: US 2026/0368571 A1
(43) Pub. Date: Nov. 19, 2026

(54) METHOD FOR PROVIDING RECOMMENDATION MENU ITEM AND ELECTRONIC DEVICE

(71) Applicant: SAMSUNG ELECTRONICS CO., LTD., Suwon-si (KR)

(72) Inventors: Seongmin JOE, Suwon-si (KR); Sanghun PARK, Suwon-si (KR); Hyesu YEOM, Suwon-si (KR); Arang JEONG, Suwon-si (KR); Hyunwoo CHUN, Suwon-si (KR)

(73) Assignee: SAMSUNG ELECTRONICS CO., LTD., Suwon-si (KR)

(21) Appl. No.: 19/724,127

(22) Filed: Jun. 29, 2026

Related U.S. Application Data
(63) Continuation of application No. PCT/KR2024/018962, filed on Nov. 27, 2024.

(30) Foreign Application Priority Data
Dec. 29, 2023 (KR) 10-2023-0197640

(51) Int. Cl. G06N 5/046

(52) U.S. Cl. CPC G06N 5/046

(57) ABSTRACT

A method of providing a recommendation menu is provided. The method includes generating data corresponding to usage patterns, during a predefined time, based on context information related to use of a service currently in use, obtaining one or more recommendation items through an artificial intelligence model receiving the generated data as an input, and providing the recommendation menu including the obtained one or more recommendation items, wherein the artificial intelligence model is a multi-label model trained by applying a recall as a performance evaluation index.

### CROSS-REFERENCE TO RELATED APPLICATIONS

This application is a continuation application of International Application No. PCT/KR2024/018962, filed on Nov. 27, 2024, which is based on and claims the benefit of Korean Patent Application Number 10-2023-0197640, filed on Dec. 29, 2023, the disclosures of which are incorporated by reference herein in their entireties.

### TECHNICAL FIELD

The present disclosure relates to a method, an electronic device, and a server for providing a user with a recommendation according to a usage context of the electronic device.

### BACKGROUND ART

Electronic devices provide various services to users through various applications and sources. In addition, users may use various settings items for adjusting settings of electronic devices or performing functions thereof.

However, as the number of functions provided by electronic devices increase, settings items are also classified in detail according to the functions and are increasing in number. Accordingly, in order to apply optimized settings to the current state of an electronic device, several menu navigation operations are required, and it is difficult to find the optimal settings due to the various settings items.

### DISCLOSURE OF INVENTION

### Solution to Problem

Aspects of embodiments of the disclosure will be set forth in part in the description which follows and, in part, will be apparent from the description, or may be learned by practice of the presented embodiments.

According to an aspect of the present disclosure, a method, performed by an electronic device, of providing a recommendation menu may be provided. The method may include generating data corresponding to usage patterns, during a predefined time, based on context information related to use of a service currently in use; obtaining one or more recommendation items through an artificial intelligence model receiving the generated data as an input; and providing the recommendation menu including the obtained one or more recommendation items, wherein the artificial intelligence model is a multi-label model trained by applying a recall as a performance evaluation index.

According to an aspect of the present disclosure, an electronic device for providing a recommendation menu may be provided. The electronic device may include a display unit; a communication interface; memory, comprising one or more storage media, storing one or more instructions; and one or more processors communicatively coupled to the memory. The instructions, when executed by the one or more processors are further configured individually or collectively, cause the electronic device to: generate data corresponding to usage patterns, during a predefined time, based on context information related to use of a service currently in use, obtain one or more recommendation items through an artificial intelligence model receiving the generated data as an input, and provide, on the display unit, a recommendation menu including the obtained one or more recommendation items, wherein the artificial intelligence model is a multi-label model trained by applying a recall as a performance evaluation index. According to an aspect of the present disclosure, a non-transitory computer-readable recording medium having recorded thereon a program for executing any one of the methods, performed by an electronic device, of providing a recommendation menu, as described above and below may be provided.

### BRIEF DESCRIPTION OF DRAWINGS

The above and other aspects, features, and advantages of certain embodiments of the disclosure will be more apparent from the following description, taken in conjunction with the accompanying drawings listed below.

FIG. 1 is a diagram schematically illustrating an operation in which an electronic device provides a recommendation, according to an embodiment of the present disclosure.

FIG. 2 is a flowchart illustrating an operation in which an electronic device provides a recommendation menu, according to an embodiment of the present disclosure.

FIG. 3 is a diagram illustrating a recommendation item inference model according to an embodiment of the present disclosure.

FIG. 4 is a diagram illustrating an operation in which an electronic device infers menu recommendation items, according to an embodiment of the present disclosure.

FIG. 5A is a diagram illustrating statistical data for training a recommendation item inference model according to an embodiment of the present disclosure.

FIG. 5B is a diagram illustrating training data for training a recommendation item inference model, according to an embodiment of the present disclosure.

FIG. 6A is a diagram illustrating menu items of an electronic device, according to an embodiment of the present disclosure.

FIG. 6B is a diagram illustrating an example of a recommendation menu generated by an electronic device, according to an embodiment of the present disclosure.

FIG. 7 is a diagram illustrating an operation in which an electronic device performs a recommendation function, according to an embodiment of the present disclosure.

FIG. 8 is a diagram illustrating an operation in which an electronic device provides a recommendation menu, according to an embodiment of the present disclosure.

FIG. 9 is a diagram illustrating an operation in which an electronic device interacts with a server, according to an embodiment of the present disclosure.

FIG. 10 is a block diagram of a configuration of an electronic device according to an embodiment of the present disclosure.

FIG. 11 is a block diagram of a configuration of an electronic device according to an embodiment of the present disclosure.

FIG. 12 is a block diagram of a configuration of a server according to an embodiment of the present disclosure.

### MODE FOR THE INVENTION

Terms used in the present specification will now be briefly described and then the present disclosure will be described in detail. Throughout the present disclosure, the expression “at least one of a, b or c” indicates only a, only b, only c, both a and b, both a and c, both b and c, all of a, b, and c, or variations thereof.

The terms used in the present disclosure may be general terms currently widely used in the art by considering functions described herein, but may vary according to an intention of skilled persons in the related art, precedent cases, advent of new technologies, etc. In addition, specific terms may be arbitrarily selected by the applicant, and in this case, the meaning of the selected terms will be described in detail in the relevant description. Thus, the terms used herein should be defined not by simple appellations thereof but based on the meaning of the terms together with the overall description of the present disclosure.

Singular expressions used herein are intended to include plural expressions as well unless the context clearly indicates otherwise. All the terms used herein, which include technical or scientific terms, may have the same meaning that is generally understood by one of ordinary skill in the art. In addition, although the terms including an ordinal number such as “first”, “second”, etc. may be used herein to describe various elements or components, these elements or components should not be limited by the terms. The terms are only used to distinguish one element or component from another element or component.

Throughout the specification, when a part “includes” or “comprises” an element, unless there is a particular description contrary thereto, it is understood that the part may further include other elements, not excluding the other elements. In addition, terms such as “unit”, “module”, etc., described herein refer to a unit for processing at least one function or operation and may be implemented as hardware or software, or a combination of hardware and software.

An embodiment of the present disclosure will be described more fully hereinafter with reference to the accompanying drawings so that the embodiment thereof may be easily implemented by one of ordinary skill in the art. However, the present disclosure may be implemented in many different forms and should not be construed as being limited to an embodiment of the present disclosure set forth herein. In addition, parts not related to the descriptions are omitted to clearly illustrate the present disclosure in the drawings, and like reference numerals denote like elements throughout.

Hereinafter, the present disclosure is described in detail with reference to the accompanying drawings.

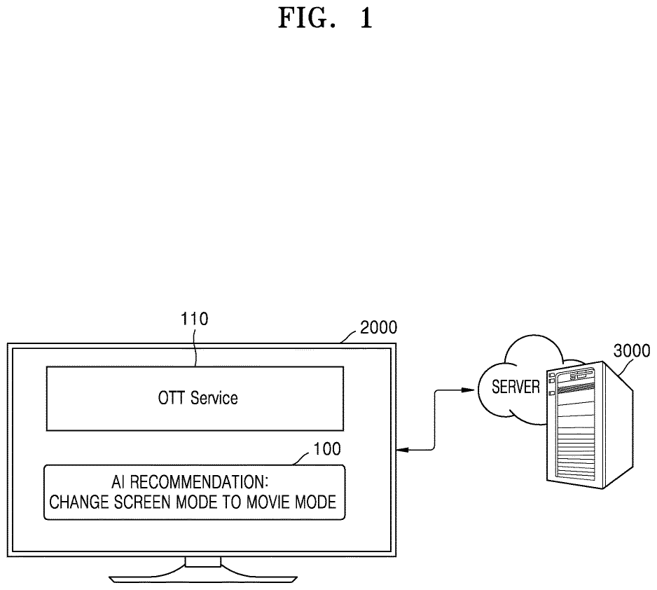

FIG. 1 is a diagram schematically illustrating an operation in which an electronic device provides a recommendation, according to an embodiment of the present disclosure.

In an embodiment, an electronic device 2000 may include a display or include various types of devices connectable to the display. For example, the electronic device 2000 may include a TV, a smart monitor, a tablet PC, a laptop PC, a digital signage, a large display, a 360-degree projector, etc., each including the display. Alternatively, the electronic device 2000 may include a set-top box, a desktop PC, etc., each connectable to the display, but is not limited thereto.

Referring to FIG. 1, the electronic device 2000 may provide a recommendation 100 to a user.

The electronic device 2000 may provide a recommendation item to the user, based on a usage context of the electronic device 2000. The recommendation item may be one or more recommendation items. For example, the electronic device 2000 may provide the recommendation 100 for changing a screen display mode of the electronic device 2000 to a movie mode, based on an over-the-top (OTT) service 110 being used in the electronic device 2000.

In an embodiment, the electronic device 2000 may use a recommendation item inference model that is an artificial intelligence (AI) model. The electronic device 2000 may obtain context information related to the use of the electronic device 2000, and analyze a usage pattern of the electronic device 2000 by using the context information. The recommendation item inference model may infer one or more recommendation items based on the usage pattern of the electronic device 2000.

In an embodiment, the electronic device 2000 may transmit and receive data necessary to provide the recommendation 100 to the user with a server 3000. For example, the electronic device 2000 may transmit the context information (e.g., usage history information, etc.) of the electronic device to the server 3000. The server 3000 may analyze usage patterns of the electronic device 2000 and other electronic devices and generate statistical data. The server 3000 may deploy a recommendation item inference model trained using the statistical data.

In an embodiment, the electronic device 2000 may receive the trained recommendation item inference model from the server 3000, and infer one or more recommendation items. In an embodiment, the electronic device 2000 may transmit the context information to the server 3000, and receive the inferred one or more recommendation items from the server 3000.

In an embodiment, the recommendation 100 may be provided in various forms. For example, the electronic device 2000 may provide a recommendation menu including one or more recommendation items. For example, the electronic device 2000 may provide one recommendation item. In addition, for example, the recommendation 100 may be provided in a form in which the electronic device 2000 automatically performs settings or functions corresponding to the recommendation item.

Specific operations in which the electronic device 2000 provides a recommendation to a user will be described in more detail through drawings and descriptions thereof below.

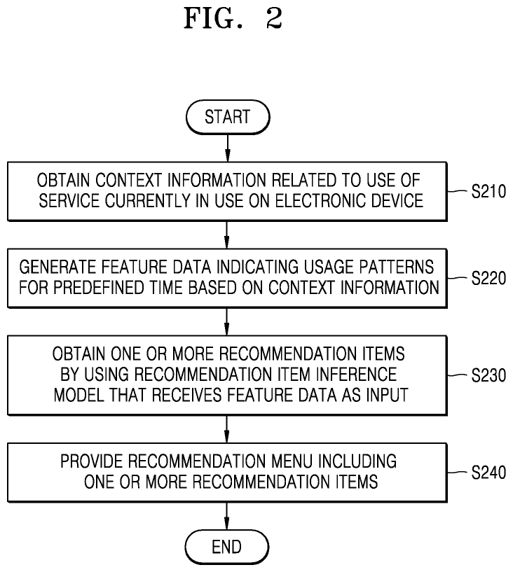

FIG. 2 is a flowchart illustrating an operation in which an electronic device provides a recommendation menu, according to an embodiment of the present disclosure.

In operation S210, the electronic device 2000 may obtain context information related to the use of a service currently in use on the electronic device 2000.

In an embodiment, context information related to the use of the service may include at least one of service category analysis information, settings history information, or usage history information.

In an embodiment, the electronic device 2000 may identify the service currently in use on the electronic device 2000. Functions and menus used in the electronic device may vary depending on a viewing environment of the electronic device 2000. In other words, usage patterns may vary depending on which services are used in the electronic device 2000, and customized recommendations provided to a user of the electronic device 2000 may vary depending on service categories. Accordingly, the electronic device 2000 may obtain service category analysis information including a category of the service currently in use. In an embodiment, service categories may be previously classified and defined as applications, sources, content, etc. The service categories may include, for example, video, games, sports, music, applications, High-Definition Multimedia Interface (HDMI) 1, HDMI 2, etc., but are not limited thereto. The service category analysis information may include the category of the service currently in use, applications and sources included in the category, the number of category usages, etc., but is not limited thereto.

The settings history information may refer to histories related to settings items applied to the electronic device 2000. In an embodiment, information related to picture settings, sound settings, mode settings, and other various settings items of the electronic device 2000 may be included in the settings history information. The settings history information may include, for example, information such as names of setting items, identification values, set values, set frequencies, set times, etc., but is not limited thereto.

The usage history information may refer to a usage history of an application executed in the electronic device 2000 and a history related to an external source connected to and used in the electronic device 2000. Applications executed in the electronic device 2000 may include applications for providing various services. In an embodiment, the applications may include an OTT service application, a game application, a video application, a music application, etc. The application usage history information may include, for example, information such as an application name, identification information, service category, the number of executions, and execution time, etc., but is not limited thereto. External sources connected to and used in the electronic device 2000 may include various devices connected to and used in the electronic device 2000. In an embodiment, the sources may include a set-top box, a desktop PC, a laptop PC, a game console, a home theater, a sound bar, etc. The history related to the external source may include information such as the type of the external source, the number of connections, connection time, etc., but is not limited thereto.

In operation S220, the electronic device 2000 may generate feature data indicating usage patterns for a predefined time based on the context information. The feature data may simply be referred to as data.

In an embodiment, the electronic device 2000 may analyze the usage history information, the settings history information, the service category in use, etc. in order to analyze the usage patterns. In addition, the electronic device 2000 may further use various pieces of information (e.g., location information, time information, weather information, etc.) that may be utilized to analyze the usage patterns.

The usage patterns may refer to usage behaviors of the electronic device 2000 at a time when menu items (e.g., function execution, settings change, etc.) of the electronic device 2000 are used. For example, when a user uses the electronic device 2000 during the daytime, the user will use a function of adjusting a screen brightness among the menu items of the electronic device 2000 due to sunlight. Alternatively, when the user uses the electronic device 2000 by connecting a game console that is an external source, the user will use a function of adjusting a screen resolution and frame rate among the menu items of the electronic device 2000. When the above-described examples are converted into data, the usage patterns may be, for example, data such as a usage frequency of the menu item, a usage time period, a time required to use the menu item, a service category in use, an application in use, a source in use, a method of use, preference settings, preference theme, etc. In addition, the usage patterns may include information about a time when the use of the menu item of the electronic device 2000 was made and which menu item was used.

In an embodiment, the usage patterns may be organized in a time series format. The electronic device 2000 may store various pieces of context information obtained as the electronic device 2000 is used, and organize usage patterns obtained based on the context information into time series data. The electronic device 2000 may select data of a period (e.g., 5 minutes, 10 minutes, etc.) that affects the use of the menu items of the electronic device 2000 from among the time series data of the usage patterns. The electronic device 2000 may subdivide the selected data into data during a predefined time (e.g., 1 minute, 1 minute and 30 seconds, etc.) The electronic device 2000 may aggregate the subdivided data and generate feature data indicating usage patterns during a predefined time. The feature data may be used as input data of a recommendation item inference model.

In operation S230, the electronic device 2000 may obtain one or more recommendation items by using the recommendation item inference model that receives the feature data as an input. The recommendation item inference model may simply be referred to as an inference model.

In an embodiment, the recommendation item inference model may be a multi-label model trained by applying a recall as a performance evaluation index. The goal of the recommendation item inference model is to output a menu item inferred to be likely to be used by the user among various menu items. Accordingly, it is important that a history of selecting an actual menu item and a history of using an actual function, which are included in training data of the recommendation item inference model, are well reflected in training. The recall represents a proportion of actual positive data that a model correctly predicted, and is defined as follows.

$$Recall = \frac{True Positives}{True Positives + False Negatives}$$

Here, true positive (TP) represents a correct inference result that the model predicted a class, and false negative (FN) represents an incorrect inference result that the model failed to predict the class. The recall is applied as the performance evaluation index, and thus, the recommendation item inference model of the present disclosure may be trained to minimize FN inference of the model. In other words, the recommendation item inference model may be a multi-label model trained to minimize FN which fails to correctly recommend an item that the user desires, rather than FP which incorrectly recommends a menu item that the user has not used.

The electronic device 2000 may obtain one or more recommendation items (e.g., menu items) output from the recommendation item inference model, and identify priorities of the recommendation items.

In operation S240, the electronic device 2000 may provide a recommendation menu including the one or more recommendation items.

In an embodiment, when the electronic device 2000 includes a display, the electronic device 2000 may display the recommendation menu on a screen. The electronic device 2000 may perform a function corresponding to a recommendation item of the recommendation menu, based on a user input for selecting the recommendation menu displayed on the screen.

In an embodiment, the electronic device 2000 may transmit recommendation menu information to another device. For example, the electronic device 2000 may transmit the recommendation menu information to another device including the display so that the recommendation menu is displayed on the other device.

In an embodiment, the electronic device 2000 may automatically perform a function corresponding to a recommendation menu item. For example, the electronic device 2000 may execute an application, change an operation mode, or change settings.

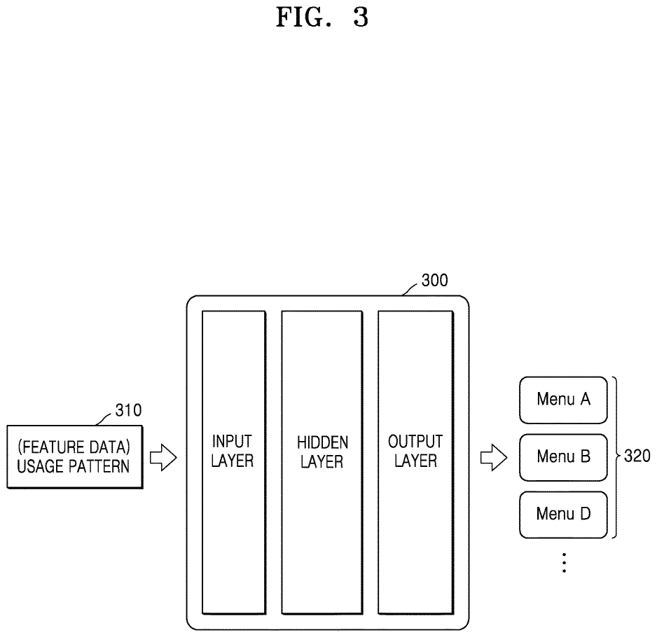

FIG. 3 is a diagram illustrating a recommendation item inference model according to an embodiment of the present disclosure.

In the present disclosure, unless otherwise stated, a ‘model’ and an ‘inference model’ refer to a recommendation item inference model 300. The recommendation item inference model 300 may be an AI model trained to receive feature data 310 and output one or more recommendation menu items 320. The recommendation item inference model 300 may be a multi-label model for inferring one or more menu items, and an inference operation of the recommendation item inference model 300 may be performed after training is completed.

The electronic device 2000 may preprocess data collected by the electronic device 2000 and generate the feature data 310. The electronic device 2000 may obtain context information including service category analysis information, usage history information, and settings history information while the electronic device 2000 is operating, and analyze a usage pattern of a user of the electronic device 2000.

In an embodiment, the generated feature data 310 may represent usage patterns during a predefined time. For example, the feature data 310 may include feature elements representing usage patterns during a previous predetermined period (e.g., the past 5 minutes). The feature elements included in the feature data 310 may include, for example, the number of usages for each service category, the number of usages for each application, the number of source usages, the number of usages for each menu item, the number of power on/off, the type of HDMI connection equipment, the number of occurrences of illumination level, etc., but are not limited thereto.

The recommendation item inference model 300 may be implemented using a deep neural network architecture and algorithm of AI for performing a multi-label classification task. In an embodiment, the recommendation item inference model 300 may be implemented through a deep neural network model including one or more multi-layer perceptron (MLP) configured as hidden layers including weights, but is not limited thereto.

In an embodiment, the recommendation item inference model 300 may include an input layer (embedding layer), a hidden layer, and an output layer.

The input layer may process the feature data 310 which is input data. For example, the input layer may generate embedding by transforming input data into vector representations for neural network operations.

The hidden layer may include one or more fully connected layers including weights. The fully connected layer may connect all nodes between input and output, and may perform an operation that applies a weight and an activation function and transmit an operation result to a next layer.

The output layer may output an inference result with respect to each class. For example, the output layer may output probability values with respect to each recommendation item.

The key to the recommendation item inference model 300 recommending an optimized menu item to the user is to provide the menu item to the user via a short path, unlike general predictions. For example, when the user needs multiple manipulation actions to select a particular menu item, it is important to provide the particular menu item immediately without the user having to perform navigation actions (e.g., cursor movement, page turning, etc.) to reach the particular menu item. Therefore, instead of applying Precision:TP/(TP+FP) which increases prediction accuracy as the performance evaluation index, the electronic device 2000 may train the recommendation item inference model 300 by applying Recall:TP/(TP+FN) which increases the accuracy of inferring trained data well as the performance evaluation index.

In an embodiment, the electronic device 2000 may use a back-propagation for multi-label learning (BP-MLL) loss function that is usable as a loss function for improving recall, during a training process of the recommendation item inference model 300. However, the loss function is not limited to the BP-MLL loss function.

In an embodiment, the electronic device 2000 may adjust various parameter values to minimize and optimize a value of the loss function during the training process of the recommendation item inference model 300. Parameters for optimization may include, for example, an optimizer, an initializer, etc. Examples of optimizer may include, but are not limited to, Adaptive Moment Estimation (Adam), Root Mean Square Propagation (RMSprop), Stochastic Gradient Descent (SGD), Adaptive Gradient Algorithm (Adagrad), etc.

In an embodiment, when training the recommendation item inference model 300, the electronic device 2000 may apply an optimized hyperparameter (e.g., a learning rate, etc.) to improve recall.

In an embodiment, the recommendation item inference model 300 may be trained on the electronic device 2000.

In an embodiment, the recommendation item inference model 300 may be trained on the server 3000. The electronic device 2000 may receive the trained recommendation item inference model 300 from the server 3000.

In an embodiment, the recommendation item inference model 300 may be trained on the server 3000, and operated on the server 3000. The electronic device 2000 may transmit the input data to the server 3000, and receive output data (e.g., a recommendation item inference result) from the server 3000.

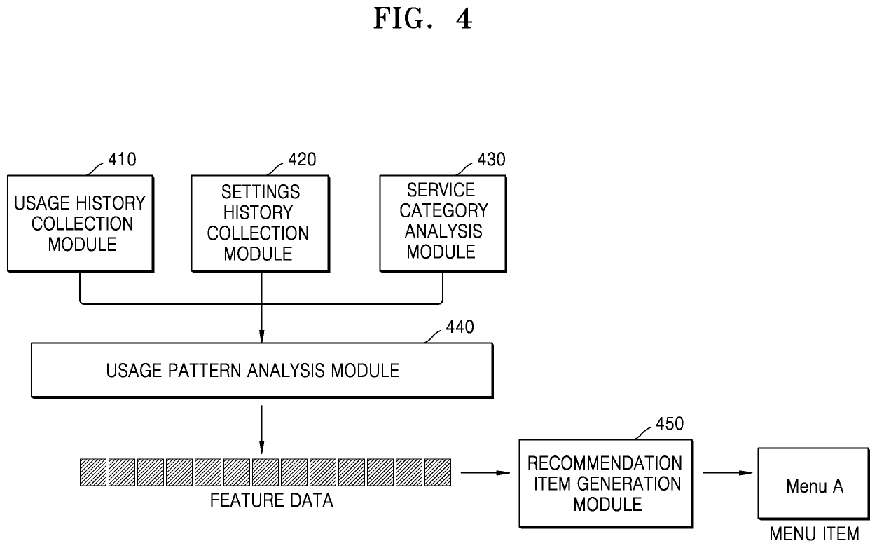

FIG. 4 is a diagram illustrating an operation in which an electronic device infers menu recommendation items, according to an embodiment of the present disclosure.

In an embodiment, the electronic device 2000 may include a usage history collection module 410, a settings history collection module 420, a service category analysis module 430, a usage pattern analysis module 440, and a recommendation item generation module 450. Each module may be configured as a combination of a series of codes and data for implementing a specific function, and may be stored in memory of the electronic device 2000. Each module may process operations corresponding to some of tasks performed by the electronic device 2000 to provide a recommendation menu. Each module may interact while transferring data to each other. A processor of the electronic device 2000 may process a task corresponding to the function of each module, by executing instructions of code constituting the module. Hereinafter, the function of each module will be described.

The usage history collection module 410 may collect a usage history of an application executed in the electronic device 2000 and a history related to an external source connected to and used in the electronic device 2000. The usage history collection module 410 may manage collected usage history information. The usage history collection module 410 may transmit the collected usage history information to the usage pattern analysis module 440.

The settings history collection module 420 may collect histories related to applied settings items. The settings history collection module 420 may manage collected settings history information and transmit the collected settings history information to the usage pattern analysis module 440.

The service category analysis module 430 may collect analysis information related to service categories. For example, the electronic device 2000 may identify a service category currently in use on the electronic device 2000 and obtain information about the service category currently in use. For example, the electronic device 2000 may collect applications and sources included in the category, the number of category usages, etc. The service category analysis module 430 may manage collected service category analysis information and transmit the collected service category analysis information to the usage pattern analysis module 440.

The usage pattern analysis module 440 may analyze usage patterns of the electronic device 2000 by using the usage history information, the settings history information, and the service category analysis information. The usage patterns may refer to usage behaviors of the electronic device 2000 at a time when menu items of the electronic device 2000 are used. For example, when a user uses the electronic device 2000 at night, the user will use a function of adjusting a screen mode of the electronic device 2000 to a night mode. With respect to a menu item ‘night mode’, the electronic device 2000 may generate data, as usage patterns, including a usage frequency of the menu item, a usage time period, a time required to use the menu item, a service category in use, the application in use, a source in use, etc.

In an embodiment, the electronic device 2000 may generate feature data indicating usage patterns during a predefined time, by using the usage pattern analysis module 440. For example, the electronic device 2000 may generate feature data including feature elements representing usage patterns during a previous predetermined period (e.g., the immediate preceding predetermined period, the past 1 minute, and the past 5 minutes). The feature data may be used as input data of a recommendation item inference model.

The recommendation item generation module 450 may include the recommendation item inference model. The recommendation item generation module 450 may operate the recommendation item inference model and manage recommendation items. An inference operation of the recommendation item inference model may be performed by an inference code. The recommendation item inference model may receive the feature data and output one or more recommendation items.

In an embodiment, when a user input is received, the electronic device 2000 may generate feature data indicating usage patterns during a time prior to the user input based on a time when the user input is received. The electronic device 2000 may input the feature data to the recommendation item inference model and obtain one or more recommendation items.

In an embodiment, the user input may be obtained in various ways. The user input may include, for example, a touch input to a screen of the electronic device 2000, an input through a peripheral device connected through an input/output (I/O) interface of the electronic device 2000, an input received from another device, etc., but is not limited thereto.

In an embodiment, the user input may be an input through another device (e.g., a remote controller, a smartphone, etc.) For example, the electronic device 2000 may initiate a series of operations for providing a recommendation menu, based on a user input through a remote controller.

In an embodiment, the user input may be a voice input. The voice input may be received through a microphone included in the electronic device 2000, or may be received through a microphone included in a remote controller or another electronic device (e.g., a smartphone) and transmitted to the electronic device 2000.

The electronic device 2000 may convert a user voice input into text by using automatic speech recognition (ASR). In addition, the electronic device 2000 may process natural language text by using a natural language processing (NLP) model. The electronic device 2000 may initiate a series of operations for providing a recommendation menu in response to various forms of natural language voice commands. For example, the electronic device 2000 may provide a recommendation menu according to a voice command such as “Run the recommendation menu function”, and may provide a recommendation menu related to settings of an application A according to a voice command such as “Run the application A”.

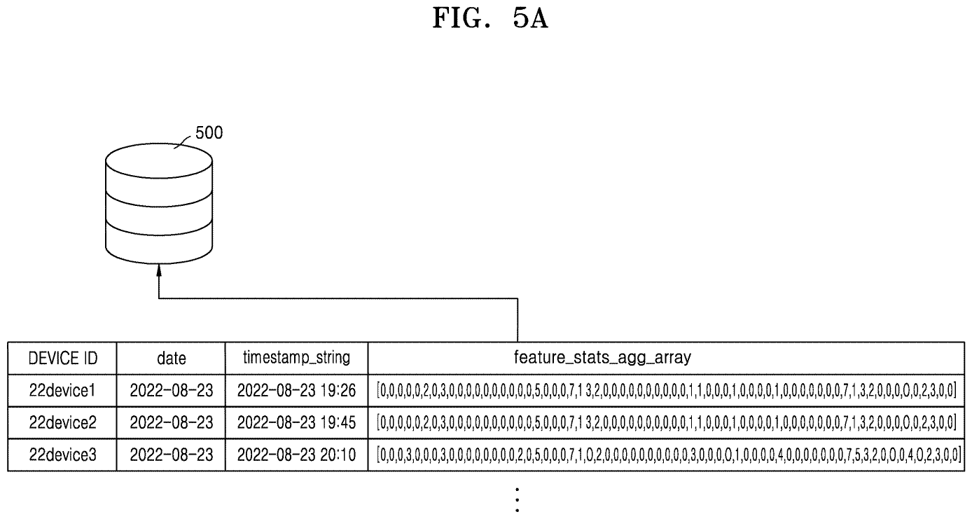

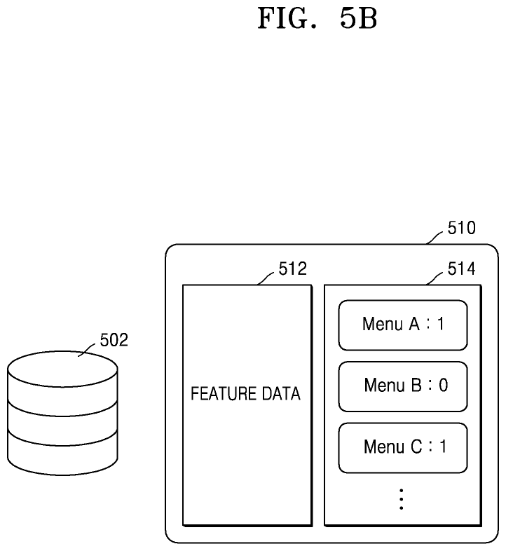

FIG. 5A is a diagram illustrating statistical data for training a recommendation item inference model according to an embodiment of the present disclosure.

In an embodiment, the electronic device 2000 may train the recommendation item inference model before performing an inference operation using the recommendation item inference model.

The electronic device 2000 may obtain statistical data 500 of usage patterns and settings histories of a plurality of other electronic devices. The statistical data 500 may include training data representing the usage patterns of other electronic devices. In other words, there are a plurality of other electronic devices, and a collection of training data representing a usage pattern of each of the other electronic devices is referred to as the statistical data 500. The training data may be an array of aggregated feature sets, but is not limited thereto.

In an embodiment, the statistical data 500 may be training data generated by each of a plurality of other electronic devices and received by electronic device 2000. In an embodiment, the electronic device 2000 may generate the statistical data 500 by obtaining raw data from a plurality of other electronic devices, and analyzing usage patterns of the plurality of other electronic devices. In an embodiment, the electronic device 2000 may obtain the statistical data 500 from the server 3000. An operation in which other electronic devices or the server 3000 generates training data may be performed in the same or a similar manner as an operation in which the electronic device 2000 generates training data. An operation in which the electronic device 2000 generates training data will be further described with reference to FIG. 5B.

FIG. 5B is a diagram illustrating training data for training a recommendation item inference model according to an embodiment of the present disclosure.

In an embodiment, the electronic device 2000 may generate training data 502 for training the recommendation item inference model. Training data 510 included in the training data 502 may be data in the form of one-hot encoding that represents recommendation items 514 that have been actually used with respect to feature data 512 in a binary format.

In an embodiment, the feature data 512 represents usage patterns during a predefined time. The electronic device 2000 may organize the usage patterns into time series data. The electronic device 2000 may select data of a period (e.g., 5 minutes, 10 minutes, etc.) that affects the use of menu items of the electronic device 2000 from among the time series data of the usage patterns. The electronic device 2000 may subdivide the selected data into data during a predefined time (e.g., 1 minute, 1 minute and 30 seconds, etc.) The electronic device 2000 may aggregate the subdivided data and generate the feature data 512 indicating the usage patterns during the predefined time. The feature data 512 may be in the form of an array of numerical feature sets, but is not limited thereto.

In an embodiment, the electronic device 2000 may fine-tune the recommendation item inference model by using the training data 502. By reflecting the usage pattern of a user of the electronic device 2000 in the recommendation item inference model, the electronic device 2000 may update the recommendation item inference model to be optimized to suit the user's preference of the electronic device 2000.

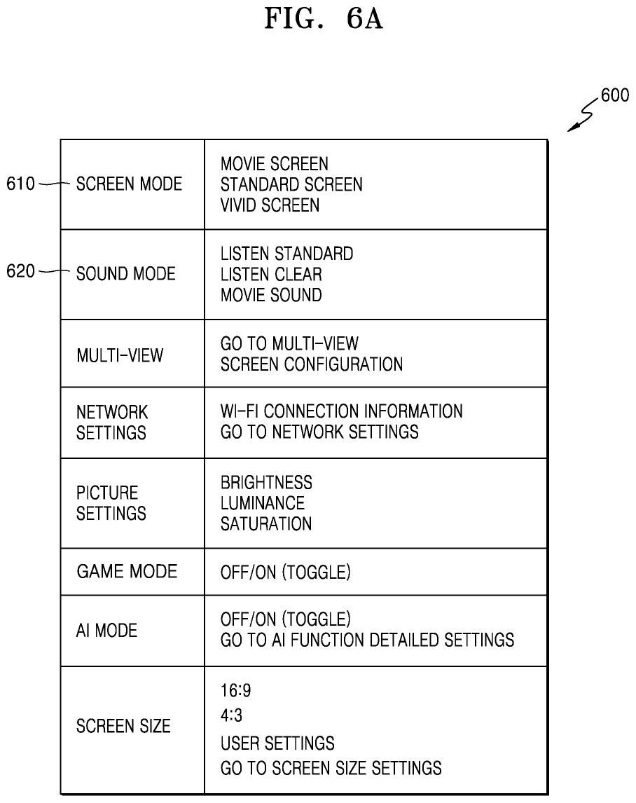

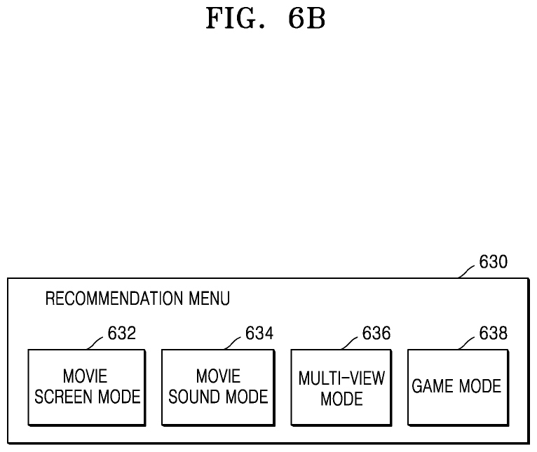

FIG. 6A is a diagram illustrating menu items of an electronic device according to an embodiment of the present disclosure.

In an embodiment, menu items 600 of the electronic device 2000 may be configured in a tree structure in which items for applying various settings are classified into an upper category, a lower category, etc.

For example, when a ‘screen mode 610’ item is selected from the menu items 600, the electronic device 2000 may display sub-menu items for applying settings such as ‘movie screen’, ‘standard screen’, and ‘vivid screen’. In addition, when a ‘sound mode 620’ item is selected from the menu items 600, the electronic device 2000 may display sub-menu items for applying settings such as ‘listen standard’, ‘listen clear’, and ‘movie sound’.

In an embodiment, when a user applies settings or performs a function by using the menu items 600 of the electronic device 2000, the user needs to go through several operation actions to use different items of the menu items 600.

For example, when the user wants to change the screen mode 610 to a ‘vivid screen’, menu items need to be selected in the order of ‘settings’, ‘screen mode 610, and ‘vivid screen’, and several manipulation actions (e.g., movement, selection, etc.) are included until a ‘vivid screen’ item is finally reached. Thereafter, when the user wants to change the sound mode 620 to ‘listen standard’, the user needs to again go to the settings menu through a backward action or a settings menu button, and menu items need to be selected in the order of ‘settings’, ‘sound mode 620’, and ‘listen standard’.

In an embodiment, the electronic device 2000 may provide a recommendation menu that is inferred appropriately to a context in which the user currently uses the electronic device 2000, by using the recommendation item inference model. Accordingly, the electronic device 2000 may reduce user interaction cost by directly providing a specific menu item through a recommendation menu even though the user does not perform a navigation action along a predetermined path to reach a specific menu item. The interaction cost may refer to a cost (e.g., the number of clicks on a remote controller) required for the user to interact so as to apply desired settings or perform a function on the electronic device 2000. The recommendation menu will be further described with reference to FIG. 6B.

FIG. 6B is a diagram illustrating an example of a recommendation menu generated by an electronic device according to an embodiment of the present disclosure.

Referring to FIG. 6B, the electronic device 2000 may provide a recommendation menu 630. The recommendation menu 630 may include one or more recommendation items. The one or more recommendation items may be output from a recommendation item inference model.

In an embodiment, menu items may be displayed on the recommendation menu 630 without distinction between upper category/lower category. For example, the recommendation menu 630 may include menu items such as a movie screen mode 632, a movie sound mode 634, a multi-view mode 636, a game mode 638, etc. When a user wants to use a plurality of menu items in the electronic device 2000, the user needs to go to the entire settings menu and select specific settings items. However, when the user selects a menu item through the recommendation menu 630 provided by the electronic device 2000, a plurality of settings items may be applied to the electronic device 2000 with a simple operation.

In an embodiment, when providing the recommendation menu 630, the electronic device 2000 may provide the recommendation menu 630 including a menu item that has not been used in the electronic device 2000. Because the recommendation item inference model is trained using statistical data of different electronic devices of a plurality of different users, the recommendation menu 630 has not been used in the electronic device 2000, but may include a menu item suitable for a current usage context.

In an embodiment, the menu item included in the recommendation menu 630 is not limited to settings items. For example, the electronic device 2000 may include an application recommendation, a source recommendation, etc. in the recommendation menu 630.

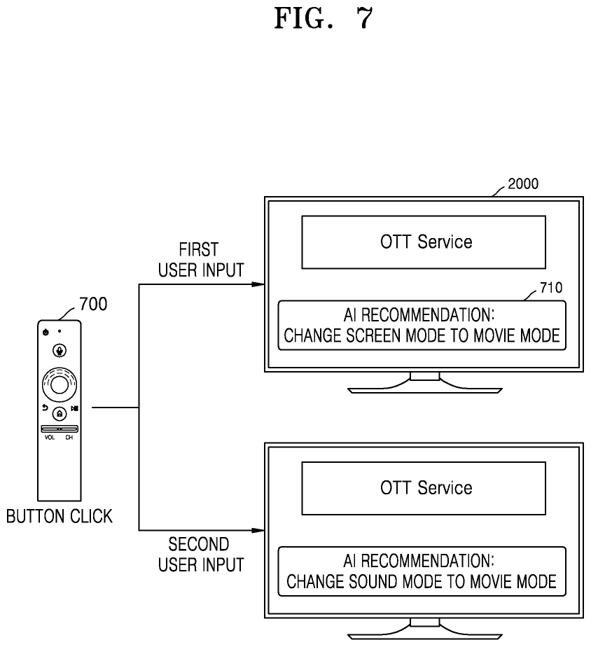

FIG. 7 is a diagram illustrating an operation in which an electronic device performs a recommendation function, according to an embodiment of the present disclosure.

In an embodiment, the electronic device 2000 may perform a function corresponding to a recommendation item. The electronic device 2000 may receive a user input. The user input may be input by a user to receive a recommendation menu from the electronic device 2000. The electronic device 2000 may initiate a series of operations for providing the recommendation menu based on receiving the user input. In this case, even though the user does not directly input which menu to use to the electronic device 2000, the electronic device 2000 may immediately provide the user with settings and functions that are currently necessary.

In an embodiment, the user input may be an input through another device (e.g., a remote controller 700, a smartphone, etc.) For example, the electronic device 2000 may initiate operations for providing the recommendation menu based on the user input through the remote controller 700. The electronic device 2000 may obtain context information related to a service (e.g., OTT service) currently in use on the electronic device 2000, based on receiving a signal indicating a user input pressing a specific button from the remote controller 700. The electronic device 2000 may generate feature data representing usage patterns during a time preceding the user input with respect to a time when the user input is received, based on the context information. The electronic device 2000 may input the feature data to the recommendation item inference model and obtain one or more recommendation items. The above operations have been described in detail with reference to the previous drawings, and thus, repeated descriptions thereof are omitted.

In an embodiment, the electronic device 2000 may perform a function corresponding to the recommendation item. For example, when the user input through the remote controller 700 is identified, the electronic device 2000 may perform a function of changing a screen mode. The electronic device 2000 may change the screen mode to a ‘movie mode’ which is a screen mode suitable for the ‘OTT service’ currently in use. The electronic device 2000 may display, on the screen, a notification 710 indicating that the recommendation function has been performed. For example, the electronic device 2000 may notify that the screen mode has automatically changed to the movie mode according to a first user input through the remote controller 700.

In an embodiment, a plurality of items may be included in the recommendation menu. When the plurality of items are included in the recommendation menu, the electronic device 2000 may perform a function corresponding to a recommendation item having the highest priority. The priority of recommendation items may be determined according to scores of recommendation item classes output from the recommendation item inference model.

In an embodiment, the electronic device 2000 may obtain a plurality of user inputs, and allow a plurality of functions to be performed. When the first user input is received, the electronic device 2000 may perform a first function included in the recommendation menu, and when a second user input is received, the electronic device 2000 may perform a second function included in the recommendation menu. For example, when the first user input is received through the remote controller 700, the electronic device 2000 may change the screen mode to the movie mode. In addition, when the second user input is received through the remote controller 700, the electronic device 2000 may change a sound mode to the movie mode.

In an embodiment, the electronic device 2000 may perform a recommendation function based on a user voice input. For example, the electronic device 2000 may perform a recommendation function according to a voice command such as “Run the recommendation menu function”. For example, the electronic device 2000 may perform a recommendation function related to the OTT service according to a voice command such as “Run the OTT service”.

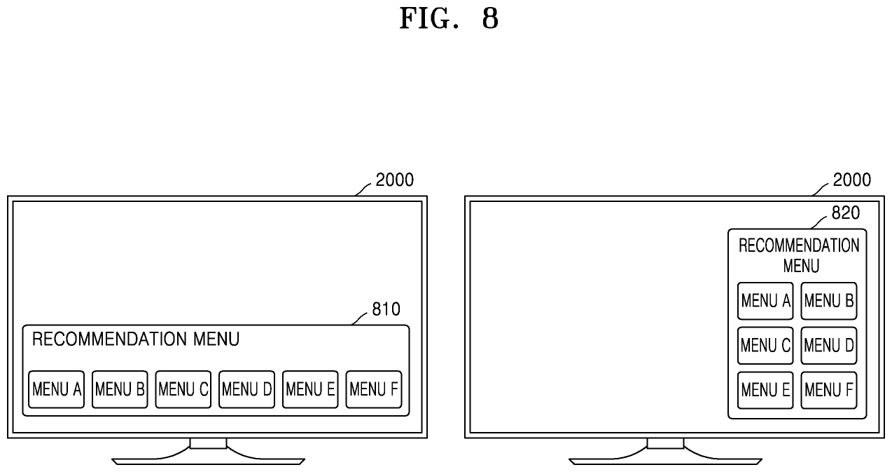

FIG. 8 is a diagram illustrating an operation in which an electronic device provides a recommendation menu, according to an embodiment of the present disclosure.

According to an embodiment, the electronic device 2000 may display the recommendation menu on a screen. The recommendation menu may include one or more recommendation items. Recommendation items may include, for example, settings item recommendation, function recommendation, application recommendation, source recommendation, etc., but are not limited thereto.

The electronic device 2000 may display the recommendation menu in various ways. The recommendation menu may be, for example, a horizontal menu 810 in which a horizontal length of a recommendation menu window is greater than a vertical length. The horizontal menu 810 may be displayed in a lower area of the screen of the electronic device 2000, but is not limited thereto. In addition, the recommendation menu may be, for example, a vertical menu 820 in which the vertical length of the recommendation menu window is greater than the horizontal length. The vertical menu 820 may be displayed, for example, in a side area of the screen of the electronic device 2000, but is not limited thereto.

In an embodiment, the electronic device 2000 may display the recommendation menu based on a user input. For example, the electronic device 2000 may initiate a series of operations for providing the recommendation menu based on receiving the user input. The electronic device 2000 may display the generated recommendation menu in the form of the horizontal menu 810 or the vertical menu 820.

In an embodiment, the electronic device 2000 may change a display method of the recommendation menu based on a user input.

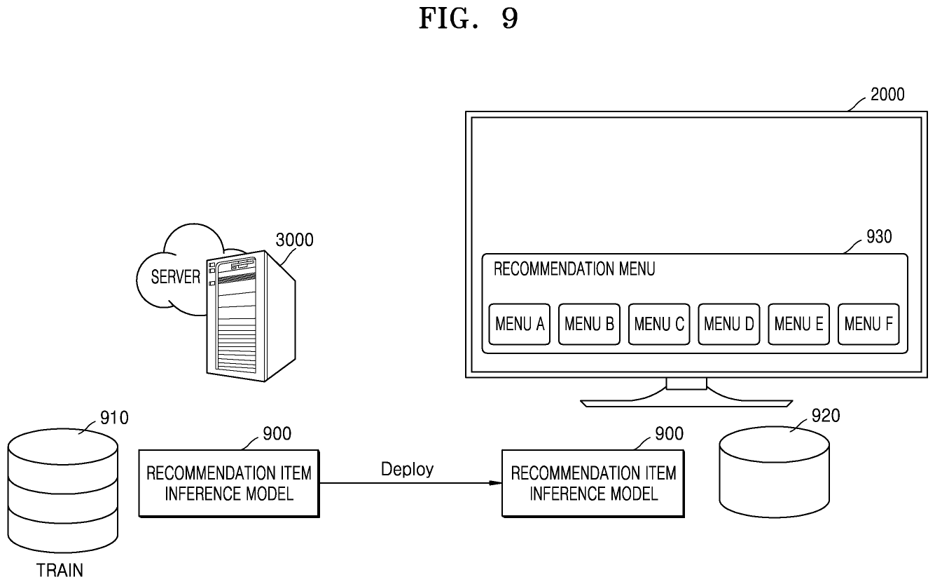

FIG. 9 is a diagram illustrating an operation in which an electronic device interacts with a server according to an embodiment of the present disclosure.

In an embodiment, the server 3000 may train a recommendation item inference model 900. The server 3000 may train the recommendation item inference model by using statistical data 910 of a plurality of electronic devices of a plurality of users. The server 3000 may generate the statistical data 910. The server 2000 may analyze usage patterns of the plurality of electronic devices based on context information (usage history information, settings history information, and service category analysis information) of the plurality of electronic devices. The server 3000 may organize the usage patterns of the plurality of electronic devices into time series data, and select data of a period (e.g., 5 minutes, 10 minutes, etc.) that affects the use of a menu item from among the time series data of the usage patterns. The server 3000 may subdivide the selected data into data during a predefined time (e.g., 1 minute, 1 minute and 30 seconds, etc.) The server 3000 may aggregate the subdivided data and generate feature data indicating usage patterns during a predefined time. The server 3000 may generate a plurality of pieces of feature data with respect to the plurality of electronic devices and generate the statistical data 910. The server 3000 may complete training of the recommendation item inference model 900 by using the statistical data 910, and verify the performance. The server 3000 may deploy the trained recommendation item inference model 900 to enable an inference operation to be performed on an electronic device.

The electronic device 2000 may generate feature data 920 representing usage patterns of the electronic device 2000 during a predefined time, and input the feature data 920 to the recommendation item inference model 900 to obtain one or more recommendation items. The electronic device 2000 may provide a recommendation menu 930 including the one or more recommendation items. For example, the electronic device 2000 may display the recommendation menu 930 on a screen of the electronic device 2000. The operations in which the electronic device 2000 generates a recommendation menu have already been described with reference to the previous drawings, and thus, repeated descriptions thereof are omitted for simplicity.

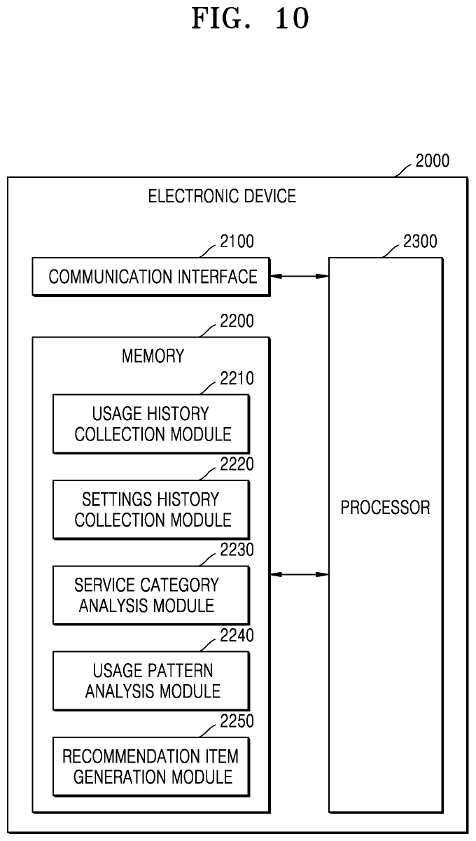

FIG. 10 is a block diagram of a configuration of an electronic device according to an embodiment of the present disclosure.

In an embodiment, the electronic device 2000 may include a communication interface 2100, a memory 2200, and a processor 2300.

The communication interface 2100 may include a communication circuit. The communication interface 2100 may use at least one of data communication methods including, for example, wired local area network (LAN), wireless LAN, Wi-Fi, Bluetooth, ZigBee, Wi-Fi Direct (WFD), infrared Data Association (IrDA), Bluetooth Low Energy (BLE), near field communication (NFC), Wireless Broadband Internet (Wibro), World Interoperability for Microwave Access (WiMAX), Shared Wireless Access Protocol (SWAP), Wireless Gigabit Alliances (WiGig), or radio frequency (RF) communication. The communication interface 2100 may be implemented to include a plurality of modules (e.g., a Wi-Fi module, a Bluetooth module, etc.) for implementing the above-described communication methods.

The communication interface 2100 may transmit and receive data for performing an operation of the electronic device 2000 to and from devices. For example, the electronic device 2000 may transmit and receive data to and from the server 3000 for providing a recommendation menu through the communication interface 2100, and may transmit and receive data to and from another server (e.g., an OTT service provision server) for providing a service.

The memory 2200 may store instructions, a data structure, and a program code readable by the processor 2300. The memory 2200 may be configured as one or more memories. In the disclosed embodiments, operations performed by the processor 2300 may be implemented by executing instructions or codes of a program stored in the memory 2200.

The memory 2200 may include non-volatile memory such as read-only memory (ROM) (e.g., programmable ROM (PROM), erasable PROM (EPROM), and electrically EPROM (EEPROM)), flash memory (e.g., memory card, and solid-state drive (SSD)), and analog record-type memory (e.g., hard disk drive (HDD), magnetic tape, and optical disc), and volatile memory such as random-access memory (RAM) (e.g., dynamic RAM (DRAM) and static RAM (SRAM)).

The memory 2200 may store data, instructions, and programs that cause the electronic device 2000 to operate to provide a recommendation menu. For example, the memory 2200 may store a usage history collection module 2210, a settings history collection module 2220, a service category analysis module 2230, a usage pattern analysis module 2240, and a recommendation item generation module 2250.

The processor 2300 may control all operations of the electronic device 2000. For example, the processor 2300 may execute one or more instructions of a program stored in the memory 2200 to control all operations of the electronic device 2000. The processor 2300 may be configured as one or more processors.

The processor 2300 may execute the usage history collection module 2210 to collect and manage usage history information. The usage history information may include a usage history of an application executed in the electronic device 2000 and a history related to an external source connected to and used in the electronic device 2000. Operations of the electronic device 2000 using the usage history collection module 2210 have been described above, and thus, repeated descriptions thereof are omitted for simplicity.

The processor 2300 may execute the settings history collection module 2220 to collect and manage settings history information. The settings history information may include a history related to settings items applied to the electronic device 2000. Operations of the electronic device 2000 related to the function of the settings history collection module 2220 have been described above, and thus, repeated descriptions thereof are omitted for simplicity.

The processor 2300 may execute the service category analysis module 2230 to analyze, collect, and manage categories of services used in the electronic device 2000. Service category analysis information may include a category of a service currently in use, an application and source included in the category, the number of category usages, etc., but is not limited thereto. Operations of the electronic device 2000 related to the function of the service category analysis module 2230 have been described above, and thus, repeated descriptions thereof are omitted for simplicity.

The processor 2300 may execute the usage pattern analysis module 2240 to analyze and organize usage patterns related to the usage history, settings history, and service category of the electronic device 2000. Operations of the electronic device 2000 related to the function of the usage pattern analysis module 2240 have been described above, and thus, repeated descriptions thereof are omitted.

The processor 2300 may execute the recommendation item generation module 2250 to generate one or more recommendation items suitable for the current usage context of the electronic device 2000. The recommendation item generation module 2250 may include a recommendation item inference model and data and codes for operating the recommendation item inference model. Operations of the electronic device 2000 using the recommendation item inference model have been described above, and thus, repeated descriptions thereof are omitted for simplicity.

Meanwhile, the above-described modules stored in the memory 2200 are for convenience of explanation and are not necessarily limited thereto. Another module may be added to implement the above-described embodiment, and some of the above-described modules may be implemented as one module, or any one of the above-described models may be implemented separately into a plurality of modules.

In an embodiment, one or more processors 2300 may include at least one of a central processing unit (CPU), a graphics processing unit (GPU), an accelerated processing unit (APU), a many integrated core (MIC), a digital signal processor (DSP), or a neural processing unit (NPU). One or more processors 2300 may be implemented in the form of an integrated system-on-chip (SoC) including one or more electronic components. Each of the one or more processors 2300 may be implemented as separate hardware (H/W).

When a method according to an embodiment of the present disclosure includes a plurality of operations, the plurality of operations may be performed by the one processor 2300 or the plurality of processors 2300. For example, when a first operation, a second operation, and a third operation are performed according to a method of an embodiment, the first operation, the second operation, and the third operation may all be performed by a first processor, or the first operation and the second operation may be performed by the first processor (e.g., a general-purpose processor) while the third operation may be performed by a second processor (e.g., a dedicated AI processor). Here, an example of the second processor may be the dedicated AI processor, and the dedicated AI processor may perform computations for training/inference of AI models. However, embodiments of the present disclosure are not limited thereto.

The one or more processors 2300 according to the present disclosure may be implemented as a single-core processor or as a multi-core processor.

When a method according to an embodiment of the present disclosure includes a plurality of operations, the plurality of operations may be performed by a single core, or may be performed by a plurality of cores included in the one or more processors 2300.

Meanwhile, although not shown in FIG. 10, the electronic device 2000 may further include additional components to perform the operations described in the above-described embodiment. For example, the electronic device 2000 may further include a display, a microphone, a I/O interface, etc.

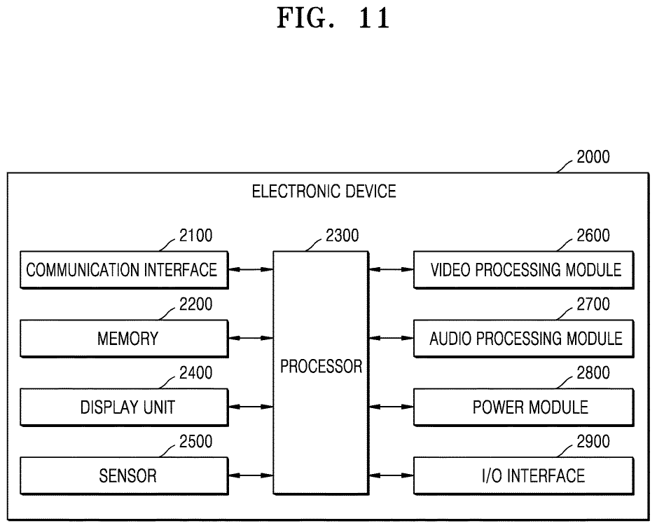

FIG. 11 is a block diagram of a configuration of an electronic device according to an embodiment of the present disclosure.

In an embodiment, the electronic device 2000 may include a communication interface 2100, memory 2200, a processor 2300, a display unit 2400, a sensor 2500, a video processing module 2600, an audio processing module 2700, a power module 2800, and an I/O interface 2900.

The interface 2100, the memory 2200, and the processor 2300 of FIG. 11 respectively correspond to the communication interface 2100, the memory 2200, and the processor 2300 of FIG. 10, and thus, repeated descriptions thereof are omitted.

The display unit 2400 may output an image signal to a screen of the electronic device 2000 according to control by the processor 2300. The display unit 2400 may include a display panel. For example, the electronic device 2000 may output a recommendation menu including one or more recommendation items on the display unit 2400.

The sensor 2500 may obtain sensor data. The processor 2300 may process the sensor data to obtain information. The sensor may be configured as one or more sensors. The sensor may include, but is not limited to, an infrared (IR) receiver for detecting a remote signal, an illuminance sensor detecting an ambient illuminance level, etc.

The video processing module 2600 performs processing on video data played by the electronic device 2000. The video processing module 2600 may perform various types of image processing, such as decoding, scaling, noise reduction, frame rate conversion, resolution conversion, rendering, etc., on the video data. The display 2400 may generate a driving signal by converting an image signal, a data signal, an on-screen display (OSD) signal, a control signal, etc. processed by the processor 2300, and display an image according to the driving signal.

The audio processing module 2700 performs processing on audio data played by the electronic device 2000. The audio processing module 2700 may perform various types of processing, such as decoding, amplification, noise reduction, etc., on the audio data.

The power module 2800 supplies, by control by the processor 2300, power input from an external power source to internal components of the electronic device 2000. In addition, the power module 2800 may supply, by control by the processor 2300, power output from one or more batteries located within the electronic device 2000 to the internal components.

The I/O interface 2900 processes an input/an output from outside of the electronic device 2000. The I/O interface 2900 receives video (e.g., a moving image, etc.), audio (e.g., voice, music, etc.), additional information (e.g., an electronic program guide (EPG), etc.), etc. The I/O interface 2900 may include one of a Universal Serial Bus (USB), an HDMI, a Mobile High-Definition Link (MHL), a DisplayPort (DP), a Thunderbolt, a Video Graphics Array (VGA) port, a red, green, and blue (RGB) port, a D-subminiature (D-sub), a Digital Visual Interface (DVI), a component jack, a PC port, and an audio jack. That is, the I/O interface 2900 may be implemented to include a plurality of modules (e.g., a USB port, an HDMI port, etc.) for implementing the above-described input/output methods. The electronic device 2000 may be connected to external devices, such as a display, a camera, a microphone, a speaker, a touch pad, etc., through the I/O interface 2900.

A user input receiver may process a user input. For example, the user input receiver may obtain and process user input and/or voice input from a microphone or touch pad connected through the I/O interface 2900. For example, the user input receiver may obtain and process user input and/or voice input from a remote controller connected through the communication interface 2100.

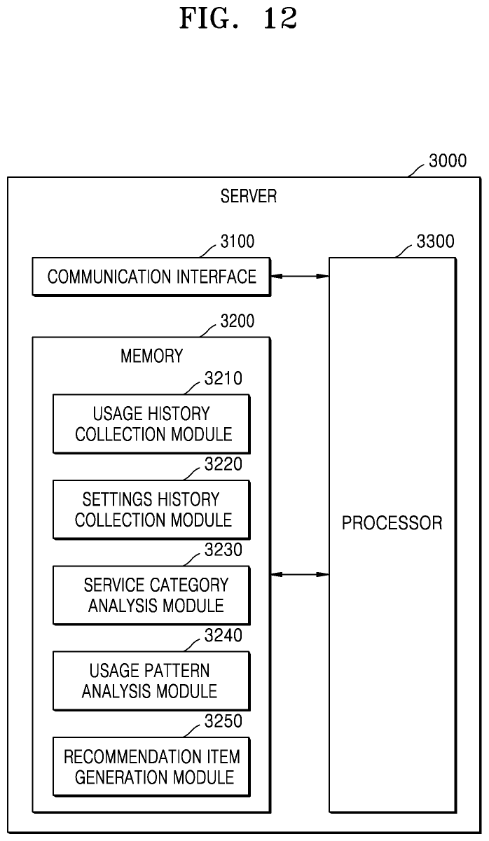

FIG. 12 is a block diagram of a configuration of a server according to an embodiment of the present disclosure.

In an embodiment, the operations performed by the electronic device 2000 or by the electronic device 2000 interacting with the server 3000 described above may be solely performed by the server 3000.

The server 3000 may include a communication interface 3100, memory 3200, and a processor 3300. The server 3000 may be a computing device with higher performance than the electronic device 2000, which is capable of processing complex operations and tasks using large amount of data, such as training, inference, management, and distribution of a recommendation item inference model.

The communication interface 3100 may perform data communication with other electronic devices by control of the processor 3300.

The communication interface 3100 may include communication circuit capable of performing data communication between the server 3000 and another electronic device (e.g., the electronic device 2000) by using at least one of data communication methods including, for example, wired LAN, wireless LAN, Wi-Fi, Bluetooth, ZigBee, WFD, IrDA, BLE, NFC, Wibro, WiMAX, SWAP, WiGig, or RF communication.

The communication interface 3100 may transmit and receive data for providing a recommendation menu to and from the electronic device 2000 by control of the processor 3300. For example, the server 3000 may receive context information (e.g., usage history information, settings history information, service category information, etc.) from the electronic device 2000 through the communication interface 3100, and may transmit information about the recommendation menu to the electronic device 2000.

The memory 3200 may store instructions, a data structure, and a program code readable by the processor 3300. Operations performed by the processor 3300 may be implemented by executing instructions or codes of the program stored in the memory 3200.

The memory 3200 may include flash memory-type memory, hard disk-type memory, multimedia card micro-type memory, or card-type memory (e.g., secure digital (SD) or extreme digital (XD) memory), non-volatile memory including at least one of ROM, EEPROM, PROM, magnetic memory, magnetic disc, or optical disc, and volatile memory, such as RAM or SRAM.

The memory 3200 may store one or more instructions and/or a program that cause the server 3000 to operate to generate a recommendation menu. For example, the memory 3200 may store a usage history collection module 3210, a settings history collection module 3220, a service category analysis module 3230, a usage pattern analysis module 3240, and a recommendation item generation module 3250. Functions of the modules have been described above, and thus, repeated descriptions thereof are omitted.

The processor 3300 may control all operations of the server 3000. For example, the processor 3300 may execute one or more instructions of the program stored in the memory 3200 to control all operations of the server 3000 for generating the recommendation menu. The processor 3300 may be configured as one or more processors.

The processor 3300 may include, but is not limited to, at least one of a CPU, a microprocessor, a GPU, application-specific integrated circuits (ASICs), DSPs, digital signal processing devices (DSPDs), programmable logic devices (PLDs), field programmable gate arrays (FPGAs), an application processor (AP), an NPU, or a dedicated AI processor designed with a hardware structure specialized for processing AI models.

The present disclosure relates to a method and an electronic device for providing a recommendation such as a settings item, an application, a source, etc. according to a usage context of the electronic device. The technical solutions to be achieved in the present disclosure are not limited to those described above, and other technical solutions not described will be clearly understood by one of ordinary skill in the art from the description herein.

According to an aspect of the present disclosure, a method, performed by an electronic device, of providing a recommendation menu is provided.

The method may include generating data corresponding to usage patterns during a predefined time, based on context information related to the use of a service currently in use on the electronic device.

The method may include obtaining one or more recommendation items through an inference model receiving the data as an input.

The method may include providing the recommendation menu including the one or more recommendation items.

The inference model may be a multi-label model trained by applying a recall as a performance evaluation index.

The context information may include at least one of histories related to settings items applied to the electronic device, a usage history of an application executed on the electronic device, or a history related to an external source connected to and used by the electronic device.

The providing of the recommendation menu may include providing the recommendation menu including a menu item that has not been used in the electronic device.

The generating of the data may include, when a user input is received, generating data corresponding to usage patterns during a time before the user input is received.

The user input may be received through a remote controller communicatively connected to the electronic device and capable of receiving the user input or a voice input.

The providing of the recommendation menu may include, when a first user input is received, performing a first function included in the recommendation menu.

The providing of the recommendation menu may include, when a second user input is received, performing a second function included in the recommendation menu.

The method may include obtaining statistical data of usage patterns and settings histories of a plurality of other electronic devices.

The method may include training the inference model by using the statistical data of the usage patterns and the settings histories of the plurality of other electronic devices.

The method may include updating the inference model based on training data in which usage patterns and settings history of the electronic device are organized in a time series format.

The updating of the inference model may include selecting data during a predetermined period from among the training data in the form of the time series format, and updating the inference model based on the data during the predetermined period.

The providing of the recommendation menu may include automatically performing a function corresponding to a recommendation item of the recommendation menu.

According to an aspect of the present disclosure, an electronic device for providing a recommendation menu is provided.

The electronic device may include a display unit, a communication interface, memory storing one or more instructions, and one or more processors configured to execute the one or more instructions stored in the memory.

The one or more processors may execute the one or more instructions to cause the electronic device to generate data corresponding to usage patterns during a predefined time, based on context information related to the use of a service currently in use on the electronic device.

The one or more processors may execute the one or more instructions to cause the electronic device to obtain one or more recommendation items by using an inference model receiving the data as an input.

The one or more processors may execute the one or more instructions to cause the electronic device to control the display unit to provide a recommendation menu including the one or more recommendation items.

The inference model may be a multi-label model trained by applying a recall as a performance evaluation index.

The context information may include at least one of histories related to settings items applied to the electronic device, a usage history of an application executed on the electronic device, or a history related to an external source connected to and used by the electronic device.

The one or more processors may execute the one or more instructions to control the display unit to provide the recommendation menu including a menu item that has not been used in the electronic device.

The electronic device may include a user input receiver.

The one or more processors may execute the one or more instructions to cause the electronic device to, when a user input is received, generate data corresponding to usage patterns during a time before the user input is received.

The user input receiver may be a remote controller communicatively connected to the electronic device and capable of receiving the user input or a voice input.

The one or more processors may execute the one or more instructions to cause the electronic device to, when a first user input is received through the user input receiver, control a first function included in the recommendation menu to be performed.

The one or more processors may execute the one or more instructions to cause the electronic device to, when a second user input is received through the user input receiver, control a second function included in the recommendation menu to be performed.

The one or more processors may execute the one or more instructions to cause the electronic device to obtain statistical data of usage patterns and settings histories of a plurality of other electronic devices through the communication interface.

The one or more processors may execute the one or more instructions to cause the electronic device to control the inference model to be trained using the statistical data of the usage patterns and the settings histories of the plurality of other electronic devices.

The one or more processors may execute the one or more instructions to cause the electronic device to control the inference model to be updated based on training data in which usage patterns and settings history of the electronic device are organized in a time series format.

The one or more processors may execute the one or more instructions to cause the electronic device to select data during a predetermined period from among the training data in the form of the time series format, and update the inference model based on the data during the predetermined period.

The one or more processors may execute the one or more instructions to cause the electronic device to automatically perform a function corresponding to a recommendation item of the recommendation menu.

Meanwhile, embodiments of the present disclosure may be implemented in the form of recording media including instructions executable by a computer, such as a program module executed by the computer. The computer-readable recording media may be any available media that are accessible by a computer, and include both volatile and nonvolatile media and both removable and non-removable media. In addition, the computer-readable recording media may include computer storage media and communication media. The computer storage media include both volatile and nonvolatile and both removable and non-removable media implemented using any method or technology for storage of information such as computer-readable instructions, data structures, program modules, or other data. The communication media typically embody computer-readable instructions, data structures, program modules, or other data in a modulated data signal.

In addition, a computer-readable storage medium may be provided in the form of a non-transitory storage medium. Here, the ‘non-transitory storage medium’ only denotes a tangible device and does not include a signal (e.g., electromagnetic waves). This term does not distinguish a case where data is stored in the storage medium semi-permanently and a case where the data is stored in the storage medium temporarily. For example, the ‘non-transitory storage medium’ may include a buffer where data is temporarily store.

According to an embodiment, a method according to various embodiments of the present disclosure in the specification may be provided by being included in a computer program product. The computer program product, which is a commodity, may be traded between sellers and buyers. The computer program product may be distributed in the shape of machine-readable storage medium (e.g., compact disc read only memory (CD-ROM)), or distributed (e.g., downloaded or uploaded) through an application store or directly and online between two user devices (e.g., smartphones). In the case of online distribution, at least a part of the computer program product (e.g., a downloadable app) may be at least temporarily generated or temporarily stored in a machine-readable storage medium, such as a server of a manufacturer, a server of an application store, or memory of a relay server.

The aforementioned descriptions of the present disclosure are merely examples, and one of ordinary skill in the art may easily understand that various modifications may be made therein without departing from the spirit or features of the present disclosure. Therefore, it is to be understood that the embodiments described above should be considered in a descriptive sense only and not for purposes of limitation. For example, configuring components that are singular forms may be executed in a distributed fashion, and also, configuring components that are distributed may be combined and then executed.

The scope of the present disclosure is defined not by the above detailed description but by the following claims, and all modifications derived from the meaning and scope of the claims and equivalent concepts thereof should be construed as being included in the scope of the present disclosure.

1. A method of operating an electronic device to provide a recommendation menu, the method comprising:
generating data corresponding to usage patterns, during a predefined time, based on context information related to use of a service currently in use;
obtaining one or more recommendation items through an artificial intelligence model receiving the generated data as an input; and
providing the recommendation menu including the obtained one or more recommendation items,
wherein the artificial intelligence model is a multi-label model trained by applying a recall as a performance evaluation index.

2. The method of claim 1, wherein the context information includes at least one of histories related to settings items applied to the electronic device, a usage history of an application executed on the electronic device, or a history related to an external source connected to and used by the electronic device.

3. The method of claim 1, wherein the providing of the recommendation menu comprises:
providing the recommendation menu including a menu item that has not been used in the electronic device.

4. The method of claim 1, wherein the generating of the data comprises:
when a user input is received, generating data corresponding to usage patterns during a time before the user input is received.

5. The method of claim 4, wherein the providing of the recommendation menu comprises:
when a first user input is received, performing a first function included in the provided recommendation menu, and
when a second user input is received, performing a second function included in the provided recommendation menu.

6. The method of claim 1, further comprising:
obtaining statistical data of usage patterns and settings histories of a plurality of other electronic devices; and
training the artificial intelligence model by using the obtained statistical data of the usage patterns and the settings histories of the plurality of other electronic devices.

7. The method of claim 1, further comprising:
updating the artificial intelligence model based on training data in which usage patterns and settings history of the electronic device are organized in a time series format.

8. An electronic device comprising:
a display unit;
a communication interface;
memory, comprising one or more storage media, storing one or more instructions; and
one or more processors communicatively coupled to the memory;
wherein the instructions, when executed by the one or more processors are further configured individually or collectively, cause the electronic device to:
generate data corresponding to usage patterns, during a predefined time, based on context information related to use of a service currently in use,
obtain one or more recommendation items through an artificial intelligence model receiving the generated data as an input, and
provide, on the display unit, a recommendation menu including the obtained one or more recommendation items,
wherein the artificial intelligence model is a multi-label model trained by applying a recall as a performance evaluation index.

9. The electronic device of claim 8, wherein the context information includes at least one of histories related to settings items applied to the electronic device, a usage history of an application executed on the electronic device, or a history related to an external source connected to and used by the electronic device.

10. The electronic device of claim 8, wherein the instructions, when executed by the one or more processors are further configured individually or collectively, cause the electronic device to:
provide, on the display unit, the recommendation menu including a menu item that has not been used in the electronic device.

11. The electronic device of claim 8, wherein the instructions, when executed by the one or more processors are further configured individually or collectively, cause the electronic device to:
when a user input is received, generate data corresponding to usage patterns during a time before the user input is received.

12. The electronic device of claim 11, wherein the instructions, when executed by the one or more processors are further configured individually or collectively, cause the electronic device to:
when a first user input is received through the user input receiver, perform a first function included in the provided recommendation menu, and
when a second user input is received through the user input receiver, perform a second function included in the provided recommendation menu.

13. The electronic device of claim 8, wherein the instructions, when executed by the one or more processors are further configured individually or collectively, cause the electronic device to:
obtain statistical data of usage patterns and settings histories of a plurality of other electronic devices through the communication interface, and
train the artificial intelligence model by using the obtained statistical data of the usage patterns and the settings histories of the plurality of other electronic devices.

14. The electronic device of claim 8, wherein the instructions, when executed by the one or more processors are further configured individually or collectively, cause the electronic device to:
update the artificial intelligence model based on training data in which usage patterns and settings history of the electronic device are organized in a time series format.

15. A non-transitory computer-readable recording medium having recorded thereon a program for controlling an electronic device to execute the method of claim 1.
